(19) United States
(12) Patent Application Publication
(10) Pub. No.: US 2014/0331257 A1
(43) Pub. Date: Nov. 6, 2014

(54) INFORMATION PROCESSING SYSTEM AND INFORMATION PROCESSING METHOD

(71) Applicants: Satoko Miki, Tokyo (JP); Kensuke Ueda, Tokyo (JP)

(72) Inventors: Satoko Miki, Tokyo (JP); Kensuke Ueda, Tokyo (JP)

(73) Assignee: Mitsubishi Electric Corporation, Tokyo (JP)

(21) Appl. No.: 14/361,682

(22) PCT Filed: Nov. 21, 2012
(86) PCT No.: PCT/JP2012/080229

§ 371 Date: May 29, 2014

(30) Foreign Application Priority Data
Nov. 30, 2011 (JP) 2011-261757

(51) Int. Cl. H04N 21/61; H04N 21/24; H04N 21/442; H04N 21/234; H04N 21/44; H04N 7/173; G06F 13/00

(52) U.S. Cl. CPC H04N 21/615; H04N 7/173; H04N 21/2402; G06F 13/00; H04N 21/23424; H04N 21/44008; H04N 21/44016; H04N 21/44209
USPC 725/32

(57) ABSTRACT

An information processing system configured from multiple digital broadcast program analysis devices (100), which are information processing devices connected to a network, includes: a request analyzing section (122) for analyzing a request presented to the information processing system, and identifying functions necessary for accomplishing the request; a function cumulation section (123) for identifying, from among digital broadcast program analysis devices (100), a digital broadcast program analysis device (100) that executes each identified function; and a sequence assembly section (124) for identifying an operating sequence for execution of the identified functions by the identified digital broadcast program analysis devices (100), and for causing the identified digital broadcast program analysis devices (100) to execute the identified functions in accordance with the identified operating sequence.

### TECHNICAL FIELD

The present invention relates to an information processing system and an information processing method.

### BACKGROUND ART

In digital broadcasting, program content such as the program title and subtitle information is transmitted together with the audio and video data as data representing the program content. There are also devices and methods for obtaining program related information from another device through the Internet etc. (see, for example, patent reference 1).

### PRIOR ART REFERENCES

### Patent References

Patent reference 1: Japanese Patent Application Publication No. 2009-212859 (paragraphs 0047-0052, FIG. 1)

### SUMMARY OF THE INVENTION

### Problems to be Solved by the Invention

The device described in patent reference 1 has within it a search keyword data generation section for extracting keyword, a content information acquisition section for acquiring content information, and a content information display section to execute all of the processes such as generating keyword data, acquiring content information, and displaying the content information. Constraints therefore arise, such as the need to have a high performance CPU (Central Processing Unit) because of the need to carry out processing at high speed in order to rapidly find and display program related information. Furthermore, the software for this type of processing becomes complex.

An object of the present invention is therefore to provide techniques that can use multiple devices to process information efficiently.

### Means for Solving the Problem

An information processing system according to one aspect of the invention is configured as a plurality of information processing devices connected to a network. The information processing system has a request analyzing section for analyzing a request presented to the information processing system and identifying functions needed to fulfill the request, a function cumulation section for identifying, from among the plurality of information processing devices, an information processing device to execute each of the identified functions, and a sequence assembly section for identifying an operating sequence in which the identified information processing devices are to execute the identified functions, and causing the identified information processing devices to execute the identified functions according to the identified operating sequence.

### Effects of the Invention

According to one aspect of the invention, multiple devices can be used to process information efficiently.

### BRIEF DESCRIPTION OF THE DRAWINGS

FIG. 1 is a block diagram schematically showing the configuration of a digital broadcast program analysis device according to first and second embodiments.

FIG. 2 is a block diagram schematically showing a variation of the configuration of a digital broadcast program analysis device according to the first and second embodiments.

FIG. 3 is a block diagram schematically showing the configuration of each functional section in the first embodiment.

FIG. 4 is a schematic diagram showing exemplary functional descriptive data in the first embodiment.

FIG. 5 is a block diagram schematically showing an example of the configuration of the digital broadcast program analysis device according to the first embodiment.

FIG. 6 is a configuration diagram showing a display system having a plurality of digital broadcast program analysis devices according to the first embodiment.

FIG. 7 is a flowchart illustrating processing when a request is presented to the digital broadcast program analysis device according to the first embodiment.

FIG. 8 is a schematic diagram showing an exemplary functional analysis table generated by the request analyzing section in the first embodiment.

FIG. 9 is a schematic diagram showing an exemplary functional assignment table generated by the function cumulation section in the first embodiment.

FIG. 10 is a flowchart illustrating processing when display of program related information is requested in the first embodiment.

FIG. 11 is a schematic diagram showing a functional analysis table in the first embodiment.

FIG. 12 is a schematic diagram showing a functional assignment table in the first embodiment.

FIG. 13 is a schematic diagram showing the system configuration of a display system in the first embodiment.

FIG. 14 is a schematic diagram showing a functional analysis table in the second embodiment.

FIG. 15 is a schematic diagram showing an exemplary functional analysis table in the first embodiment.

FIG. 16 is a block diagram showing the configuration of a digital broadcast program analysis device with a functional configuration configured from functional groups in the second embodiment.

FIG. 17 is a block diagram showing an exemplary grouping in a digital broadcast program analysis device for producing a display of program related information.

FIG. 18 is a block diagram schematically showing the configuration of an RSE system according to a third embodiment.

FIG. 19 is a block diagram schematically showing a variation of the configuration of an RSE system according to the third embodiment.

FIG. 20 is a block diagram schematically showing an example of the configuration of an RSE system according to the third embodiment.

FIG. 21 is a configuration diagram showing a display system having a plurality of RSE systems according to the third embodiment.

FIG. 22 is a flowchart illustrating processing when a reproduction request is presented to the RSE system according to the third embodiment.

FIG. 23 is a schematic diagram showing a functional analysis table in the third embodiment.

FIG. 24 is a schematic diagram showing a functional assignment table in the third embodiment.

FIG. 25 is a schematic diagram showing the system configuration of a display system in the third embodiment.

FIG. 26 is a block diagram showing an exemplary grouping in an RSE system implementing the reproduction of content.

### MODE FOR CARRYING OUT THE INVENTION

### First Embodiment

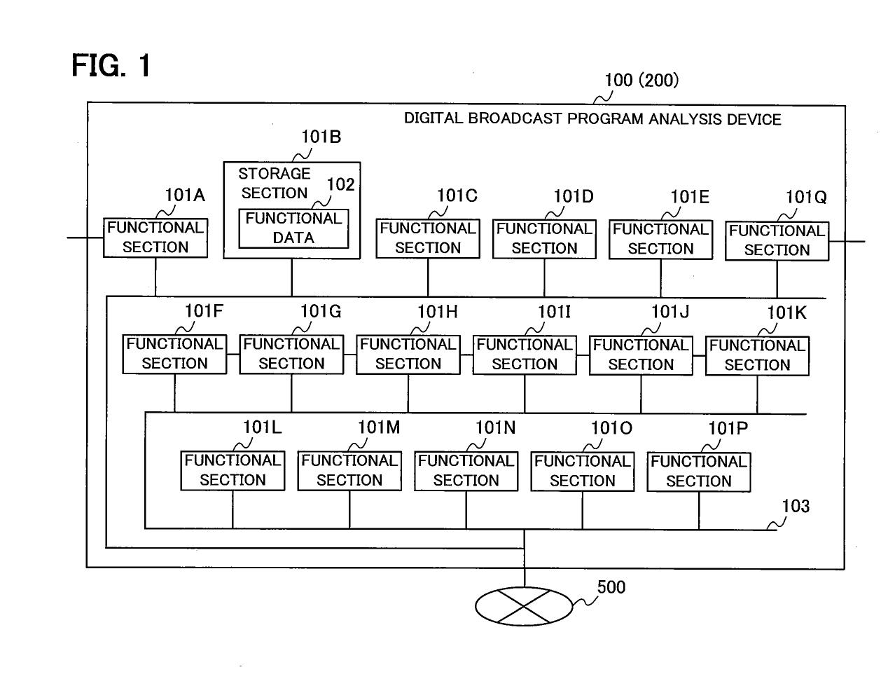

FIG. 1 is a block diagram schematically showing the configuration of a digital broadcast program analysis device 100 as an information processing device according to the first embodiment. The reference characters in parentheses in FIG. 1 apply to the second embodiment.

Reference characters 100 in FIG. 1 denote the digital broadcast program analysis device.

The 101 reference characters (101A-101Q) in FIG. 1 denote functional sections that implement respective functions in the digital broadcast program analysis device 100.

Reference characters 102 denote functional data provided in the digital broadcast program analysis device 100.

Reference characters 103 denote a network that interconnects the functional sections 101 provided in the digital broadcast program analysis device 100 and also connects the functional sections 101 to an external network.

As the external network, reference characters 500 denote the Internet.

The functional section with reference characters 101B in FIG. 1 is a storage section that stores functional data 102.

The functional data 102 are data for a request that have been analyzed and expressed as sets of functions. In other words, the functional data 102 are data that identify the functions needed to fulfill the request.

The functional sections 101 are interconnected in series or in parallel. A functional section 101 may therefore receive the output of another functional section 101 as input, or may provide output to another functional section 101. There may also be a functional section 101A that receives external input from outside the digital broadcast program analysis device 100 or a functional section 101Q that produces external output.

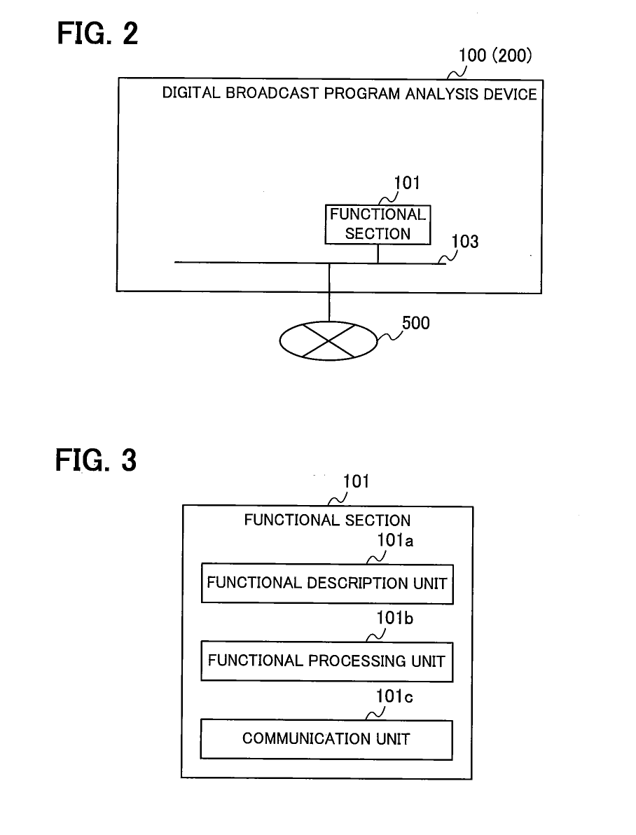

The digital broadcast program analysis device 100 includes one functional section 101 or more. There may be a digital broadcast program analysis device 100 that includes only a single functional section 101, as shown in FIG. 2. The reference characters in parentheses in FIG. 2 apply to the second embodiment.

FIG. 3 is a block diagram schematically showing the configuration of each functional section 101 in the first embodiment. Each functional section 101 is provided with a functional description unit 101a, a functional processing unit 101b, and a communication unit 101c.

The functional description unit 101a carries out processing that sends functional descriptive data to another functional section 101 through the communication unit 101c, in response to a request for a functional description from the other functional section 101; the functional descriptive data indicates the device (digital broadcast program analysis device 100) to which its own functional section 101 belongs, the function that its own functional section 101 can execute, and either the input values or the output values, or both, in the function executed by its own functional section 101. It will be assumed that the functional description unit 101a has a memory used as a functional information storage section that stores the functional descriptive data, and that functional descriptive data are stored in this memory in advance. The functional descriptive data may however be stored in another functional section 101 either in its own device or in another device.

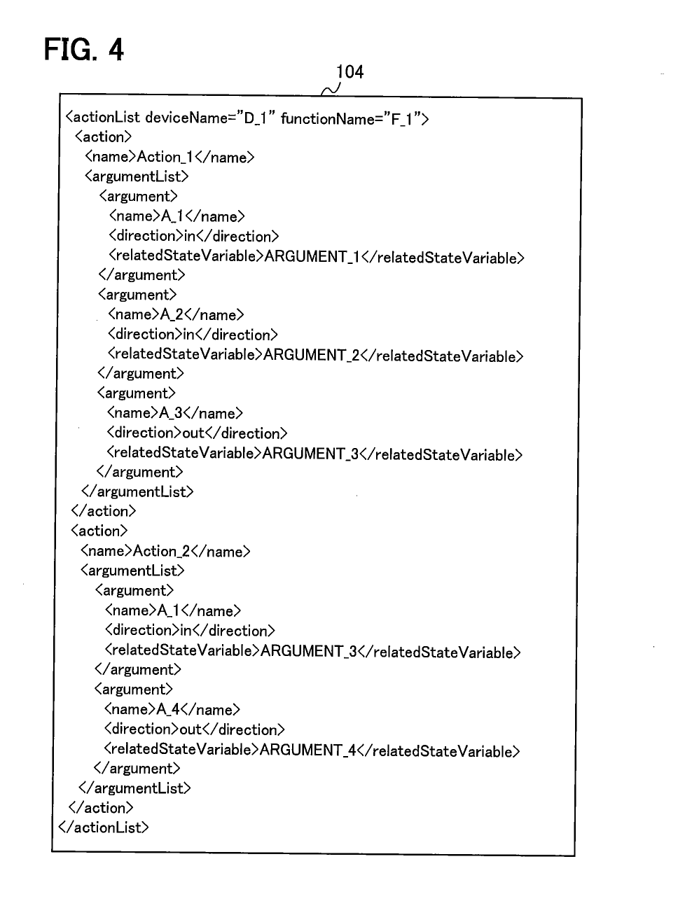

FIG. 4 is a schematic diagram showing exemplary functional descriptive data 104.

As shown, the functional descriptive data 104 have an ‘actionList’ element, and this ‘actionList’ element has a ‘deviceName’ attribute.

The value of the ‘deviceName’ attribute indicates a device name, which is device identification information for identifying the digital broadcast program analysis device 100 to which the functional section 101 belongs.

The ‘actionList’ element also has a ‘functionName’ attribute.

The value of the ‘functionName’ attribute indicates a function name, which is functional identification information for identifying each function.

The ‘actionList’ element is a set of processes (actions) for implementing the function executed by the functional sections 101 possessed by the digital broadcast program analysis device 100 identified by the value of the ‘deviceName’ attribute, expressed as a list.

For example, the ‘actionList’ element has ‘action’ elements as subelements. An ‘action’ element corresponds to a process for implementing one function executed by a functional section 101 possessed by the digital broadcast program analysis device 100 identified by the value of the ‘deviceName’ attribute.

As subelements, an ‘action’ element has a ‘name’ element and an ‘argumentList’ element. The ‘name’ element is a process name, which is process identification information for identifying a process; the ‘argumentList’ element is a list of arguments related to the execution of the process identified by the ‘name’ element.

An ‘argumentList’ element has ‘argument’ elements as subelements. An ‘argument’ element is a single argument related to the execution of the process.

An ‘argument’ element has a ‘name’ element, a ‘direction’ element, and a ‘relatedStateVariable’ element. The ‘name’ element is an argument name, which is argument identification information for identifying the argument. The ‘direction’ element is input/output identification information indicating whether the argument is an input argument or an output argument. In the ‘direction’ argument, ‘in’ indicates an input argument and ‘out’ indicates an output value. The ‘relatedStateVariable’ element is a value or argument indicating a related condition needed for executing the process.

Returning to the description of FIG. 3, the functional processing unit 101b executes a function in response to an instruction from another functional section 101 or the like.

The communication unit 101c communicates with the network 103.

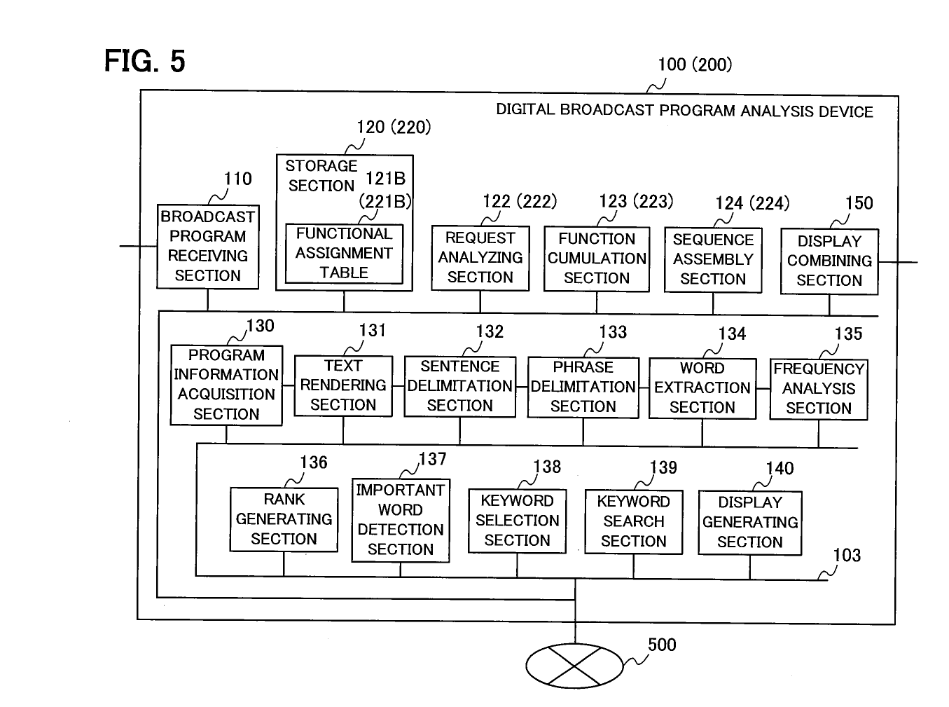

A generalized digital broadcast program analysis device 100 is configured as above; a digital broadcast program analysis device 100 that retrieves and displays program related information is configured as shown in, for example, FIG. 5.

FIG. 5 is a block diagram schematically showing an example of the configuration of the digital broadcast program analysis device 100 according to the first embodiment. Components having the same reference characters as in FIG. 1 will be assumed to be configured in the same way as in FIG. 1. The reference characters in parentheses in FIG. 5 apply to the second embodiment.

Reference characters 110 denote a broadcast program receiving section that, in the digital broadcast program analysis device 100, receives a broadcast wave and outputs video data as what is referred to as a television picture (video image) and audio data as what is referred to as television sound. The broadcast program receiving section 110 also outputs program information, included in the broadcast signal, about the program being viewed.

Reference characters 120 denote a storage section that stores a functional assignment table 121B as exemplary functional data 102, which are data listing a set of functions derived from the analyzing of a request.

Reference characters 122 denote a request analyzing section that acquires a request presented to the digital broadcast program analysis device 100, analyzes it, and generates a functional analysis table 121A.

Reference characters 123 denote a function cumulation section that identifies devices (digital broadcast program analysis devices 100) having functional sections 101 that execute functions indicated in the functional analysis table 121A. The function cumulation section 123 generates the functional assignment table 121B by updating the functional analysis table 121A by associating the identified devices with the functions indicated in the functional analysis table 121A.

Reference characters 124 denote a sequence assembly section that determines the sequence in which the functions indicated by the functional assignment table 121B will operate, and causes the functional sections 101 to perform processing in the sequence thus determined.

Reference characters 130 denote a program information acquisition section that acquires program information from the broadcast program receiving section 110. The program information acquired by the program information acquisition section 130 here is program information corresponding to the television picture and television sound output by the broadcast program receiving section 110.

Reference characters 131 denote a text rendering section that receives input of the program information from the program information acquisition section 130 and generates text data by converting the program information to text.

Reference characters 132 denote a sentence delimitation section that receives input of the text data from the text rendering section 131 and generates single sentence data by delimiting single sentences in the text data.

Reference characters 133 denote a phrase delimitation section that receives input of the single sentence data from the sentence delimitation section 132 and generates phrase data by delimiting individual phrases in the sentence data.

Reference characters 134 denote a word extraction section that receives input of the phrase data from the phrase delimitation section 133 and, by extracting words from the phrase data, generates word data indicating the extracted words.

The text rendering section 131, sentence delimitation section 132, phrase delimitation section 133, and word extraction section 134 constitute a word selection section that selects words from the program information acquired by the program information acquisition section 130. The words output by the word extraction section 134 accordingly become the words selected by the word selection section.

Reference characters 135 denote a frequency analysis section that receives input of the word data from the word extraction section 134, analyzes the frequencies of use of the words by counting the usage of each word indicated by the word data, and generates frequency analysis data indicating the frequency of use of each word.

Reference characters 136 denote a rank generating section that receives input of the frequency analysis data from the frequency analysis section 135 and generates ranking data indicating the rank of each word, giving high ranks to frequently used words, on the basis of the word frequencies indicated by the frequency analysis data.

Reference characters 137 denote an important word detection section that receives input of the ranking data from the rank generating section 136 and, on the basis of the ranking data, generates important word data indicating words (important words) ranked higher than a predetermined rank.

Reference characters 138 denote a keyword selection section that receives input of the important word data from the important word detection section 137, selects keywords for search use from among the important terms (words) indicated by the important word data, and generates keyword data indicating the selected keywords. Concerning the method by which the keyword selection section 138 selects keywords from the important words, it suffices to follow predetermined rules. For example, on the basis of a history of programs watched by the user, the keyword selection section 138 may select, as keywords to search for, words that fit the user's preferences. In this case, the keyword selection section 138 stores important words included in program information for programs viewed by the user during a predetermined past interval in a memory, not shown, that functions as an important word memory. From among the important words indicated by the important word data supplied from the important word detection section 137, the keyword selection section 138 then selects words matching the stored important words as keywords. The keyword selection section 138 may also generate screen data for an important word selection screen by processing the important words into a particular display format, output the screen data through the display combining section 150, and thereby receive, from the user, through an input section that is not shown, input selecting the keywords to search for from among the important words. Furthermore, the keyword selection section 138 may select, as keywords, all important words indicated by the important word data.

The frequency analysis section 135, rank generating section 136, important word detection section 137, and keyword selection section 138 constitute a keyword extraction section for extracting keywords from the words selected by the word selection section comprising the text rendering section 131, sentence delimitation section 132, phrase delimitation section 133, and word extraction section 134. The keywords selected by the keyword selection section 138 accordingly become the keywords extracted by the keyword extraction section.

Reference characters 139 denote a keyword search section that receives input of the keyword data from the keyword selection section 138, uses the keywords indicated by the keyword data to perform a search, and generates search result data indicating the retrieved data. The keyword search section 139, for example, performs a search, based on the keywords, for program related information from a predetermined site (server) in the Internet 500.

Reference characters 140 denote a display generating section that receives input of the search result data from the keyword search section 139 and generates display data in which the retrieved data indicated by the search result data are processed into a predetermined display format.

Reference characters 150 denote a display combining section that receives input of picture data from the broadcast program receiving section 110 and display data from the display generating section 140 and generates combined display data in which the display data are combined with the picture data.

Reference characters 103 denote a network that interconnects the broadcast program receiving section 110, storage section 120, request analyzing section 122, function cumulation section 123, sequence assembly section 124, program information acquisition section 130, text rendering section 131, sentence delimitation section 132, phrase delimitation section 133, word extraction section 134, frequency analysis section 135, rank generating section 136, important word detection section 137, keyword selection section 138, keyword search section 139, display generating section 140, and display combining section 150. The network 103 is also connected to an external network such as the Internet 500.

The relationship between FIGS. 1 and 5 will now be described. Reference characters 110, 120, 122-124, 130-140, and 150 in FIG. 5 denote exemplary functional sections 101, and reference characters 121 denote exemplary functional data 102. The digital broadcast program analysis device 100 in FIG. 5 has the functional sections indicated by reference characters 110, 120, 122-124, 130-140, and 150, but it is only necessary for a digital broadcast program analysis device 100 to have at least one of these functional sections. The storage section 120, request analyzing section 122, function cumulation section 123, and sequence assembly section 124 are preferably located in one digital broadcast program analysis device 100. If, however, these functional sections or an arbitrary combination thereof are divided among a plurality of digital broadcast program analysis devices 100, it will be assumed that the digital broadcast program analysis device 100 in which the request analyzing section 122, function cumulation section 123, or sequence assembly section 124 is located is provided with a functional section corresponding to the storage section 120. It will also be assumed that after creating the functional analysis table 121A, the request analyzing section 122 transmits the functional analysis table 121A to the function cumulation section 123, and that after creating the functional assignment table 121B, the function cumulation section 123 transmits the functional assignment table 121B and the functional descriptive data 104 acquired from each device to the sequence assembly section 124. It will also be assumed in this case that the communication address of the transmission destination is preset in the request analyzing section 122 and function cumulation section 123. Alternatively, the functional analysis table 121A and functional assignment table 121B may be located on a network that can be accessed by the request analyzing section 122, function cumulation section 123, and sequence assembly section 124 alike.

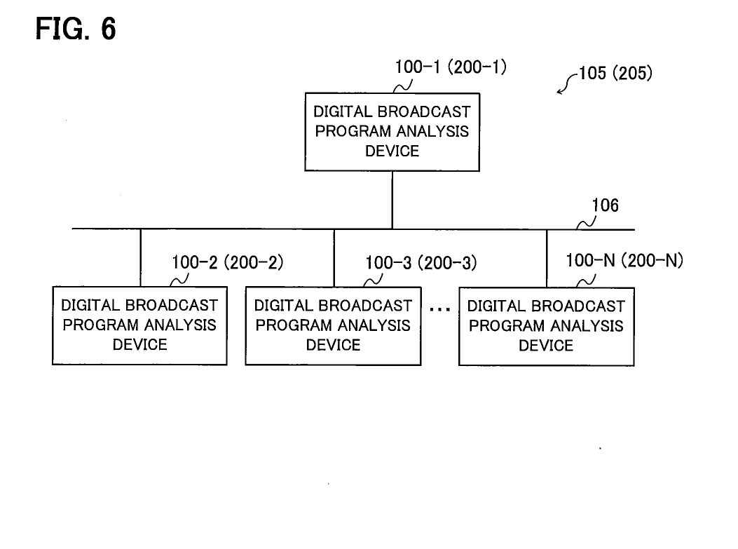

FIG. 6 is a schematic diagram of a display system 105 representing an information processing system configured by interconnecting a plurality of digital broadcast program analysis devices 100 (100-1, 100-2, 100-3, . . . , 100-N) according to the first embodiment through an external network 106 such as, for example, a LAN.

The operation of the digital broadcast program analysis device 100 according to the first embodiment configured as above will be described below.

First, the flow of processes from broadcast up to the display of program related information will be described; then how the flow of these processes is processed inside and outside the digital broadcast program analysis devices 100 will be described.

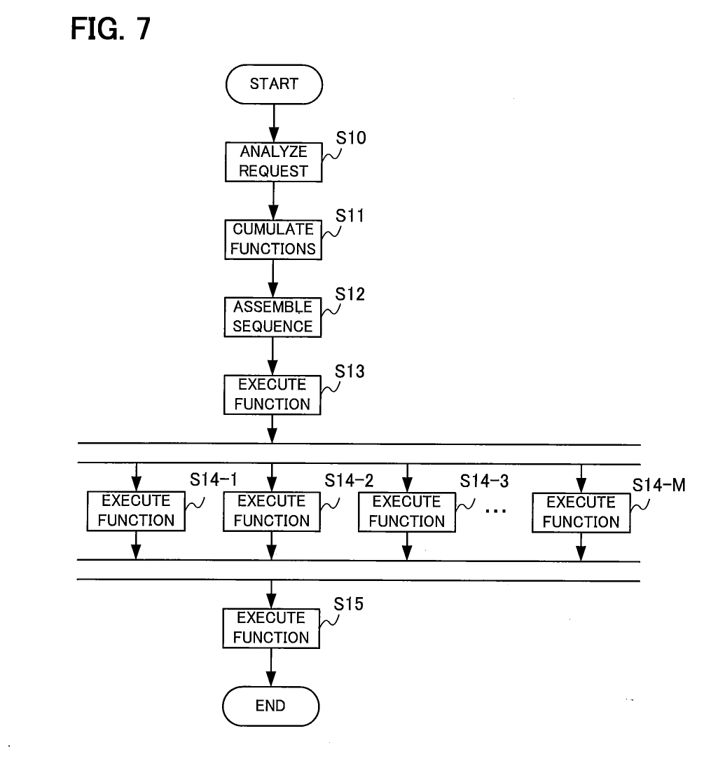

The general flow of the processes performed by a digital broadcast program analysis device 100 according to the first embodiment will be described by using FIG. 7.

FIG. 7 is a flowchart illustrating processing when a request is presented to a digital broadcast program analysis device 100. The flow shown in FIG. 7 starts with the presentation of the request to the digital broadcast program analysis device 100. It could be assumed that, for example, the request is presented to the digital broadcast program analysis device 100 when the user uses an input section (not shown), which is one of the functional sections 101, to enter the request. It might also be assumed that the digital broadcast program analysis device 100 is presented with the request when one of its functional sections 101 receives a particular notification event for example, a program switchover event reporting that the EIT (Event Information Table), which gives information about the configuration of current and following programs and is included in the digital broadcast signal, has switched from EIT[f] to EIT[p], from another functional section 101.

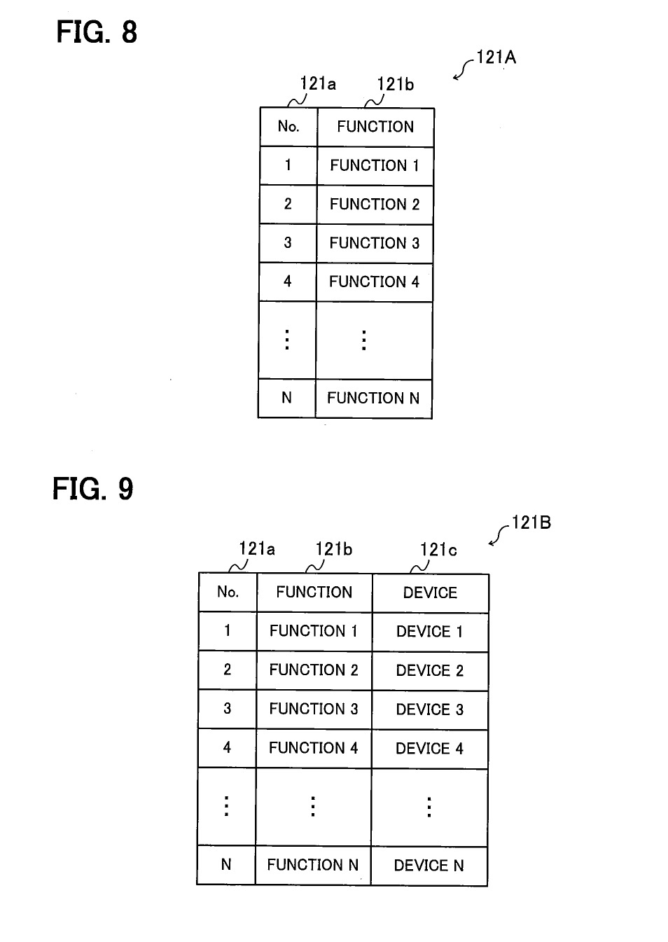

The request analyzing section 122 analyzes the request to determine the types of functions it breaks down into (S10). For example, although this is not shown, the request analyzing section 122 may have a memory used as a request analyzing storage section in which are prestored request analyzing data associating requests with the functions required by the requests. The request analyzing section 122 may also have a memory used as a dictionary storage section in which are prestored dictionary data that can identify, from a request, the functions required by the request. The request analyzing data or dictionary data may be stored in the device itself or in a functional section 101 in another device. Dictionary data may have a tree structure with the request as the root and the functions required by the request as leaves. The request analyzing section 122 generates a functional analysis table 121A as a analyzing result and stores the functional analysis table 121A in the storage section 120. The functional analysis table 121A generated in this step has the form shown in, for example, FIG. 8.

FIG. 8 is a schematic diagram showing an exemplary functional analysis table 121A generated by the request analyzing section 122. The functional analysis table 121A comprises data in a table format having a No. (number) column 121a and a function column 121b.

The No. column 121a lists identification numbers for identifying the functions.

The function column 121b stores the function name of a function required for fulfilling a given request.

Returning to the description of FIG. 7, the function cumulation section 123 identifies the device having the functional section 101 that executes each function listed in the functional analysis table 121A (S11).

For example, the function cumulation section 123 sends all the functional sections 101 included in all the digital broadcast program analysis devices 100 connected to the external network 106, as shown in FIG. 6, a functional description request asking for a functional description. Each functional section 101 that receives the functional description request sends back functional descriptive data 104 as shown in FIG. 4 in reply to the request from the function cumulation section 123.

The function cumulation section 123 cumulates the functional descriptive data 104 sent back from the other functional sections 101 and identifies the digital broadcast program analysis devices 100 having functional sections 101 that can execute the functions stored in the functional analysis table 121A. The function cumulation section 123 associates, to the functions stored in the functional analysis table 121A, digital broadcast program analysis devices 100 having functional sections 101 that can execute those functions to generate a functional assignment table 121B. The functional assignment table 121B that is generated looks like FIG. 9.

FIG. 9 is a schematic diagram showing the functional assignment table 121B generated by the function cumulation section 123. The functional assignment table 121B comprises data in a table format having a No. (number) column 121a, a function column 121b, and a device column 121c. The function cumulation section 123 generates the functional assignment table 121B by adding the device column 121c to the functional analysis table 121A generated by the request analyzing section 122.

The device column 121c lists the device names of devices having functional sections 101 that can implement the functions indicated in the function column 121b. When there are a plurality of devices with functional sections 101 that can implement a function indicated in the function column 121b, a plurality of device names are listed.

The reason why, as shown in FIG. 9, no single device (digital broadcast program analysis device 100) corresponds to the functions for fulfilling a single request is that the digital broadcast program analysis devices 100 do not all have the same functional sections 101; for example, there may be a digital broadcast program analysis device 100 with only a single functional section 101, as shown in FIG. 2. Therefore, if each digital broadcast program analysis device 100 includes at most a single functional section 101, for example, then to fulfill this type of request, N digital broadcast program analysis devices 100 including functions possessing different actions are necessary. To fulfill the request with this type of display system 105 requires a system configuration of the type shown in FIG. 6.

Returning to the description of FIG. 7, the sequence assembly section 124 refers to the input/output identification information in the functional descriptive data 104 collected from the devices corresponding to the device names listed in the functional assignment table 121B (the ‘direction’ element in FIG. 8) to determine the dependency relationships of the functions and thereby determines the operating sequence for fulfilling the request (S12).

For example, if there is a functional section 101 that inputs the output of another functional section 101, the former functional section 101 depends on the latter functional section 101, and from this dependency relation, in the operating sequence, the former functional section 101 can only operate after the latter functional section 101 has operated. In cases such as this, the operating sequence is serialized.

When there is no dependency relationship, and when a functional section 101 has a plurality of outputs which are inputs, one apiece, to next functional sections 101, the operating sequence of the functional sections 101 can be parallelized.

On the basis of the results of such analysis as the above, the sequence assembly section 124 can identify a serialized and parallelized operating sequence.

When there are a plurality of combinations that provide the functions listed in the functional assignment table 121B corresponding to a request, from among those combinations, the sequence assembly section 124 will be assumed to select one combination that can shorten the processing time, such as the most parallelizeable combination, in accordance with a predetermined rule.

The sequence assembly section 124 then has the functional sections 101 in the digital broadcast program analysis devices 100 perform the necessary functions in the identified operating sequence (steps S13 to S15).

The sequence assembly section 124 executes processing in response to the request in the identified operating sequence by, for example, a repeated procedure in which it has a functional section 101 in one digital broadcast program analysis device 100 perform one function, acquires the result (output value) of that process, and then has a functional section 101 in the next digital broadcast program analysis device 100 perform the next function. When the sequence assembly section 124 refers to the functional descriptive data 104 and has a functional section 101 perform a function, it supplies the functional section 101 with the arguments needed to execute the function.

When a functional section 101 executes a function at the direction of the sequence assembly section 124, the function is processed in the functional processing unit 101b. Here, the functional processing unit 101b may not only perform internal processing but may also execute processing via the external network 106 (Internet 500) by using processing results from external servers or the like.

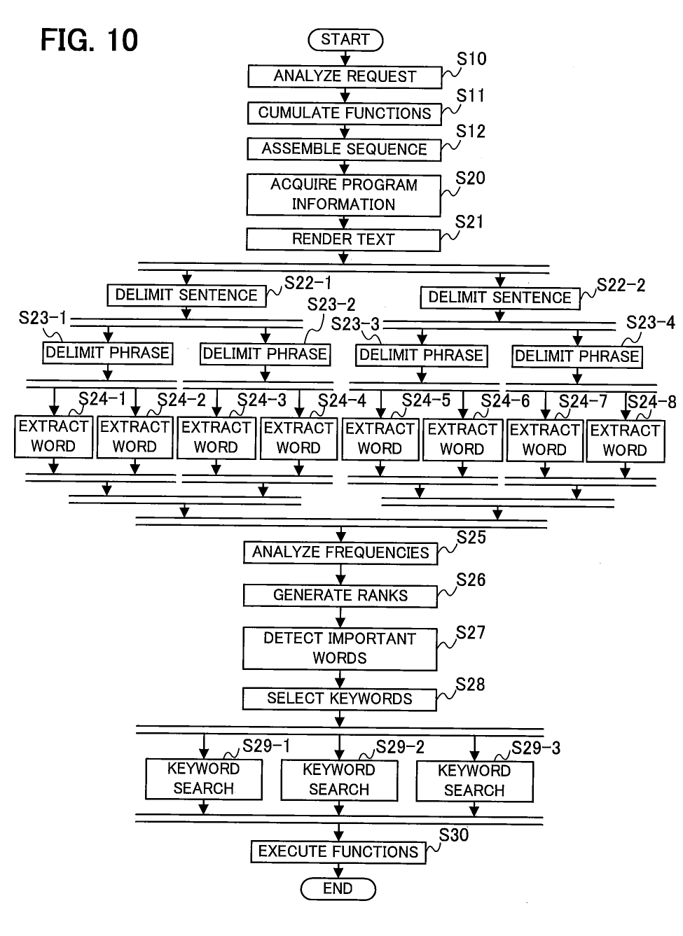

The description so far has dealt with the flow of execution of a generalized request; the case in which a request to display program related information has been made will be taken up below with reference to FIG. 10.

The processing in steps S10 to S12 in FIG. 10 is similar to the processing in steps S10 to S12 in FIG. 7.

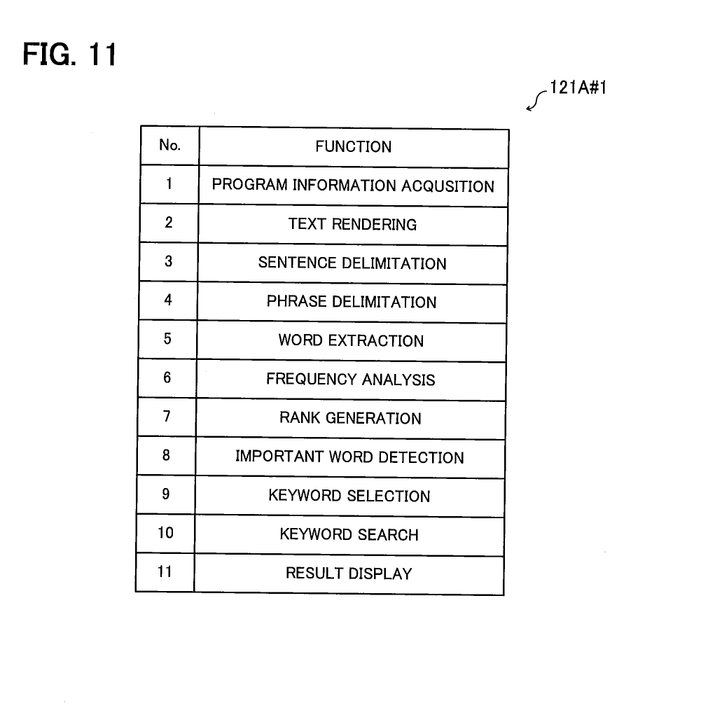

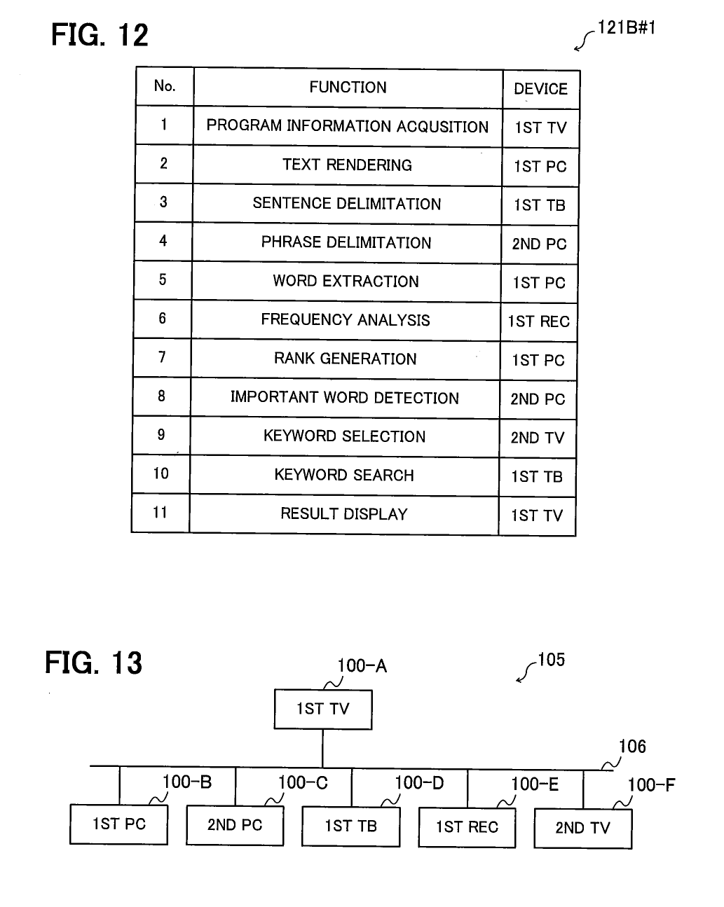

The functional analysis table 121A#1 generated here by the analysis (in step S10) of the program related information display request to display information related to a program is shown in FIG. 11. The functional assignment table 121B#1 generated by the function cumulation section 123 by identifying the devices having functional sections 101 that execute the functions listed in the functional analysis table 121A#1 is shown in FIG. 12.

In FIG. 12, six digital broadcast program analysis devices 100 constitute a system for eleven functions. A diagram of the system configuration of the display system 105 is shown in FIG. 13. The number of functions is greater than the number of digital broadcast program analysis devices 100 because the digital broadcast program analysis devices 100 constituting the display system 105 respectively include a plurality of functional sections 101. For example, the first TV 101-A includes functional sections 101 for at least a program information acquisition function and a result display function. The first TV 100-A may also include functional sections 101 for other functions, e.g., a keyword search function, but the example shown in FIG. 12 is configured such that the first TB 100-D executes the keyword search function.

Returning to the description of FIG. 10, in steps S20 to S30 in FIG. 10, the processes in the processing sequence identified in step S12 are executed according to that sequence by the corresponding devices.

FIG. 10 illustrates the flow when there are two sentences in the text data acquired from the program information, each sentence includes two phrases, and each phrase includes two words.

In this case, to execute the processing of the request efficiently, the sentence delimiting process (steps S22-1 and S22-2), the phrase delimiting process (steps S23-1 to S23-4), the word extraction process (steps S24-1 to S24-8), and the keyword search process (steps S29-1 to S29-3) are each preferably carried out in parallel.

For that purpose, by referring to the functional descriptive data 104 shown in FIG. 4, for example, the sequence assembly section 124 preferably assigns the execution of these functions to devices having more identical functions. Here, in this embodiment, there is one ‘actionList’ element per function in the functional descriptive data 104 shown in FIG. 4. The number of elements including the same ‘functionName’ is then calculated to identify the number of functions. Accordingly, when n functions are required, it is necessary to cumulate n items of functional descriptive data if they are identical to the functional descriptive data 104 in FIG. 4.

According to the digital broadcast program analysis device 100 in the first embodiment as described above, as the result of an analysis of the functions needed to execute a request to display program related information, a functional analysis table 121A is created, digital broadcast program analysis devices 100 for executing the functions are identified on the basis of this functional analysis table 121A, and an operating sequence for executing the functions is identified. Therefore, since the digital broadcast program analysis devices 100 can use the capabilities of a plurality of devices to fulfil the request, even when the processing power of each digital broadcast program analysis device 100 is low, the display of program related information can be carried out at high speed. Furthermore, since each digital broadcast program analysis device 100 only has to carry out one or more functions and the control related to those functions, the software installed in each device can be simplified.

### Second Embodiment

In the first embodiment a device was assigned to each function consisting of one or a plurality of actions; in the second embodiment, the functions are grouped and a device is assigned to execute each group.

As shown in FIG. 5, the digital broadcast program analysis device 200 according to the second embodiment has a broadcast program receiving section 110, a storage section 220, a request analyzing section 222, a function cumulation section 223, a sequence assembly section 224, a program information acquisition section 130, a text rendering section 131, a sentence delimitation section 132, a phrase delimitation section 133, a word extraction section 134, a frequency analysis section 135, a rank generating section 136, an important word detection section 137, a keyword selection section 138, a keyword search section 139, a display generating section 140, a display combining section 150, and a network 103.

The digital broadcast program analysis device 200 according to the second embodiment differs from the digital broadcast program analysis device 100 according to the first embodiment in regard to the information stored in the storage section 220 and the processing performed by the request analyzing section 222, function cumulation section 223, and sequence assembly section 224.

The storage section 220 stores a functional assignment table 221B consisting of data listing a set of functions derived from the analyzing of a request. Here, the functional assignment table 221B in the second embodiment may store, in the function column of the functional analysis table 221, not only single functions but also functional groups in which a plurality of functions are grouped.

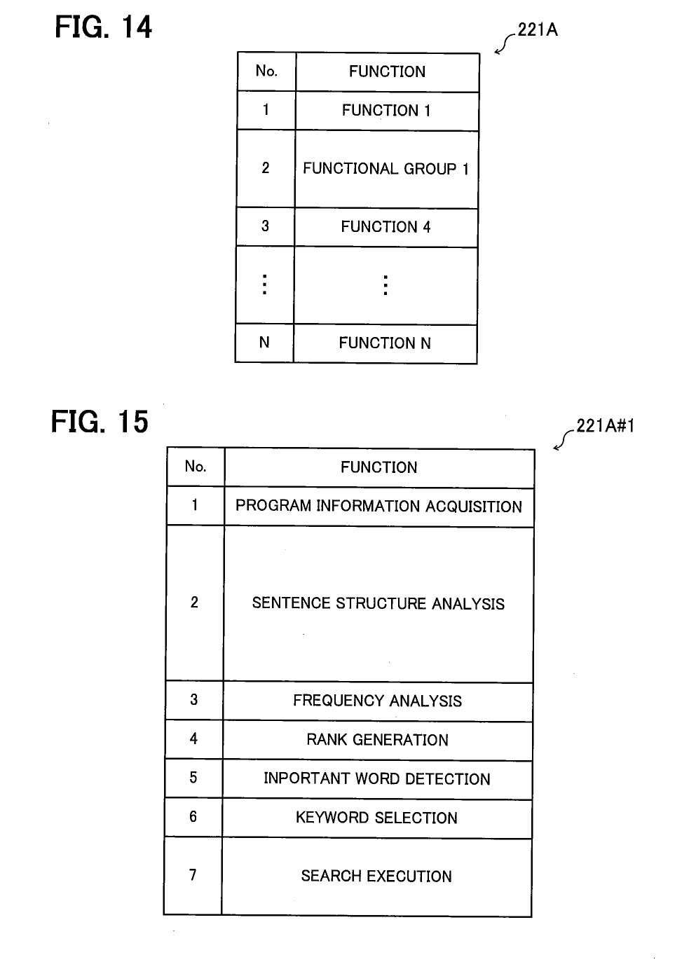

The request analyzing section 222 analyzes a request presented to the digital broadcast program analysis device 200 and generates a functional analysis table 221A. For example, although this is not shown, the request analyzing section 222 may have a memory used as a request analyzing storage section in which are prestored request analyzing data associating requests with the functions or groups of functions required by the requests. The request analyzing section 222 may also have a memory used as a dictionary storage section in which are prestored dictionary data that can identify, from a request, the functions or groups of functions required by the request. The request analyzing data or dictionary data may be stored in a functional section 101 in the device itself or in another device. Dictionary data may have a tree structure with the request as the root and the functions required by the request as leaves. The request analyzing section 222 generates a functional analysis table 221A as a analyzing result and stores the functional analysis table 221A in the storage section 220. The functional analysis table 221A generated in this step is as shown in, for example, FIG. 14. In the functional analysis table 221A shown in FIG. 14, for example ‘function 2’ and ‘function 3’ in the functional analysis table 121A shown in FIG. 8 are grouped into ‘functional group 1’. The functional analysis table 221A#1 generated by analyzing a request to display information related to a program is shown in FIG. 15. In the functional analysis table 221A#1 shown in FIG. 15, the functions ‘text rendering’, ‘sentence delimiting’, ‘phrase delimiting’, and ‘word extraction’ are grouped into a ‘sentence structure analysis’ functional group, and the functions ‘keyword search’, and ‘result display’ are grouped into a ‘search execution’ functional group.

The function cumulation section 223 identifies a device having a functional section 101 that executes each function or functional group listed in the functional analysis table 221A. Here the function cumulation section 223 assigns one device to execute the functions included in a functional group. In doing this the function cumulation section 223 may acquire, from the request analyzing section 222, function identification information indicating the functions included in the functional group. The function cumulation section 123 generates the functional assignment table 221B by updating the functional analysis table 221A by associating the identified devices with the functions or functional groups listed in the functional analysis table 221A generated by the request analyzing section 222.

The sequence assembly section 224 determines the sequence in which the functions or functional groups indicated by the functional assignment table 221B will operate, and causes the functional sections 101 to perform processing in the sequence thus determined.

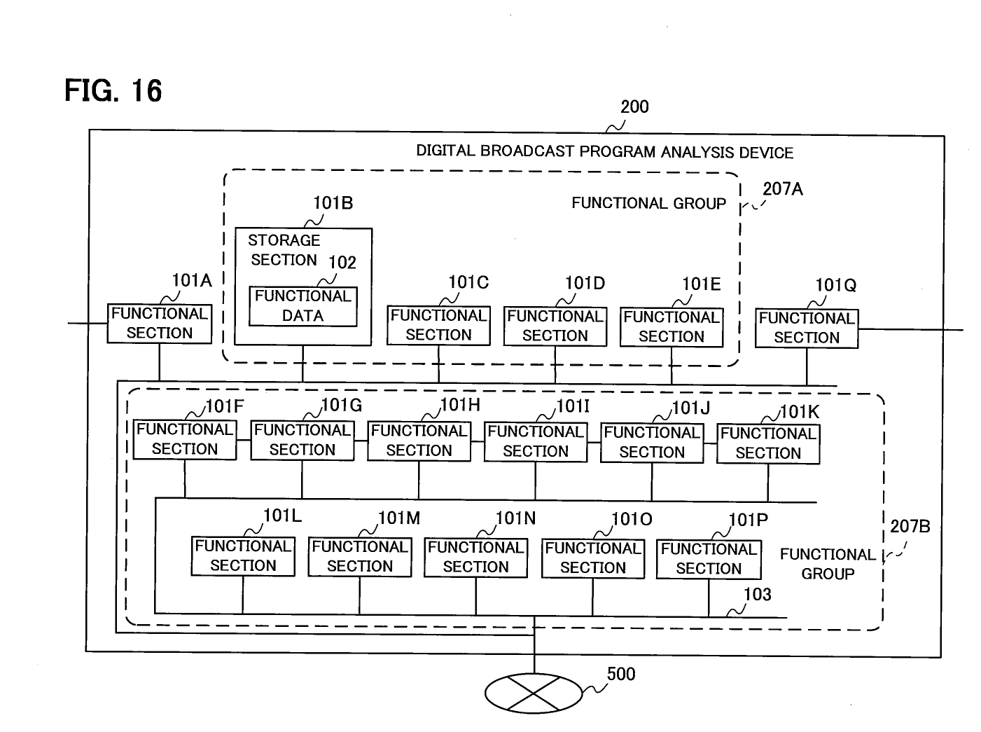

The functional groups discussed above are groups of a plurality of functions that can be executed by some one of the digital broadcast program analysis devices 200-1 to 200-N constituting the display system 205 shown in FIG. 6. A block diagram of an exemplary digital broadcast program analysis device 200 with a functional structure configured from functional groups is shown in FIG. 16. In the digital broadcast program analysis device 200 shown in FIG. 16, functional sections 101B to 101E are grouped into a functional group 207A, while functional sections 101F to 101P are grouped into a functional group 207B.

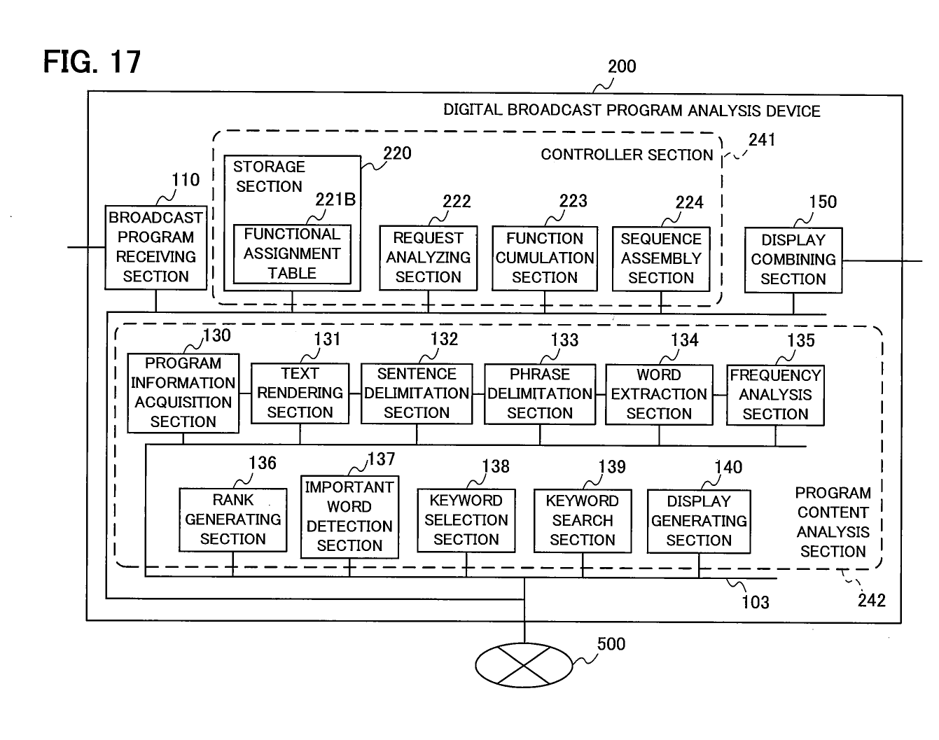

FIG. 17 is a block diagram showing an exemplary grouping in a digital broadcast program analysis device 200 for producing a display of program related information. In the digital broadcast program analysis device 200 shown in FIG. 17, the storage section 220, request analyzing section 222, function cumulation section 223, and sequence assembly section 224 are grouped together as a controller section 241. The program information acquisition section 130, text rendering section 131, sentence delimitation section 132, phrase delimitation section 133, word extraction section 134, frequency analysis section 135, rank generating section 136, important word detection section 137, keyword selection section 138, keyword search section 139, and display generating section 140 are grouped together as a program content analysis section 242.

According to the digital broadcast program analysis device 200 in the second embodiment as described above, since requests are analyzed into groups of functions, and one device is identified to execute each group of functions, the construction of the operating sequence in which the request is executed is less complex. In addition, a request can be fulfilled by a small number of digital broadcast program analysis devices 200. The cost of providing enough digital broadcast program analysis devices 200 to fulfill user requests can therefore be reduced.

In the first and second embodiments described above, as shown in FIG. 3, each functional section 101 has a communication unit 101c for connection with the network 103. This arrangement is merely exemplary, however, and is not limiting; for example, one of the functional sections 101 constituting the digital broadcast program analysis device 100 or 200 may be a communication unit for connection to the external network 106. In that case, at least two or more functional sections 101 are needed in the digital broadcast program analysis device 100 or 200. The functional sections 101 constituting the digital broadcast program analysis device 100 or 200 may also exchange information over an internal bus instead of a network 103.

### Third Embodiment

As the information processing devices in the first and second embodiments, digital broadcast program analysis devices 100, 200 were described; as the information processing device in the present embodiment, an RSE (Rear Seat Entertainment) system will be described. An RSE system is a system for viewing, listening, and control of DVD (registered trademark), BD (registered trademark), and other audio and video media in the rear seat of an automobile.

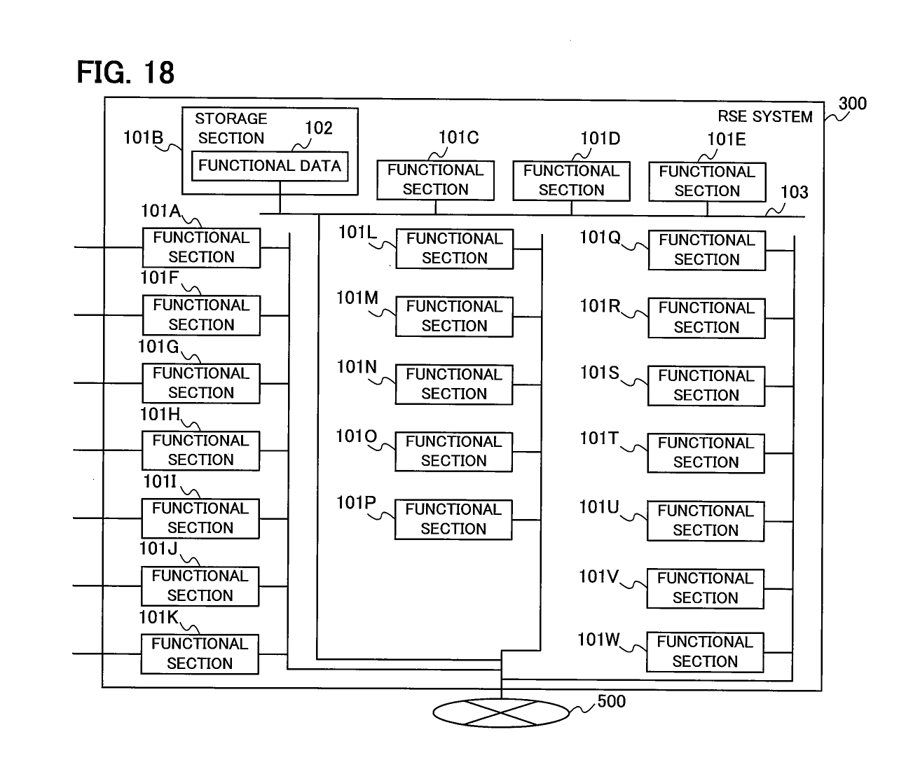

FIG. 18 is a block diagram schematically showing the configuration of an RSE system 300 used as an information processing device according to the third embodiment. The reference characters in parentheses in FIG. 18 apply to the second embodiment.

Reference characters 300 in FIG. 18 denote the RSE system.

The 101 reference characters (101A-101W) are functional sections that implement respective functions in the RSE system 300.

Reference characters 102 denote functional data provided in the RSE system 300.

Reference characters 103 denote a network that interconnects the functional sections 101 provided in the RSE system 300 and also connects the functional sections 101 to an external network.

As the external network, reference characters 500 denote the Internet.

The functional section with reference characters 101B in FIG. 18 is a storage section that stores functional data 102A.

The functional data 102 are data for requests that have been analyzed and expressed as sets of functions. In other words, the functional data 102, like the functional data 102 in the first embodiment, are data that identify the functions needed to fulfill a request.

The functional sections 101 are interconnected in series or in parallel. A functional section 101 may therefore receive the output of another functional section 101 as input, or may provide output to another functional section 101. There may also be a functional section 101A that receives external input from outside the RSE system 300 or a functional section 101Q that produces external output.

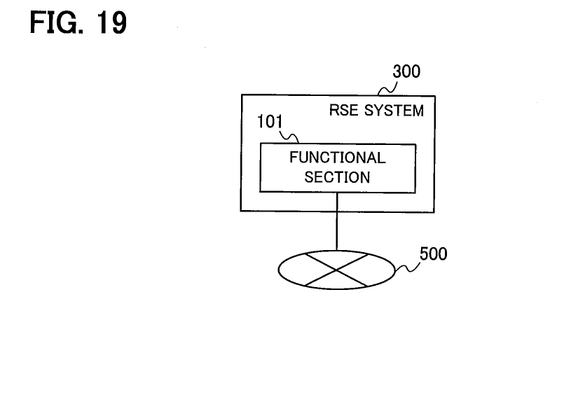

The RSE system 300 includes one functional section 101 or more. There may be an RSE system 300 that includes only a single functional section 101, as shown in FIG. 19.

As in the first and second embodiments and as shown in FIG. 3, each functional section 101 is provided with a functional description unit 101a, a functional processing unit 101b, and a communication unit 101c. These units operate as in the first and second embodiments.

For example, the functional description unit 101a carries out processing that sends functional descriptive data to another functional section 101 through the communication unit 101c, in response to a request for a functional description from the other functional section 101, the functional descriptive data indicates the device (RSE system 300) to which its own functional section 101 belongs, the function that its own functional section 101 can execute, and either the input values or the output values, or both, in the function executed by its own functional section 101. It will be assumed that the functional description unit 101a has a memory used as a functional information storage section that stores functional descriptive data, and that functional descriptive data are stored in this memory in advance. The functional descriptive data may be stored in a functional section 101 in its own device or in another device.

The functional descriptive data in the present embodiment are similar to the functional descriptive data in the first and second embodiments; FIG. 4 is a schematic diagram showing exemplary functional descriptive data 104.

As shown, the functional descriptive data 104 have an ‘actionList’ element, and this ‘actionList’ element has a ‘deviceName’ attribute.

The value of the ‘deviceName’ attribute indicates a device name, which is device identification information for identifying the RSE system 300 to which the functional section 101 belongs.

The ‘actionList’ element also has a ‘functionName’ attribute.

The value of the ‘functionName’ attribute indicates a function name, which is functional identification information for identifying each function.

The ‘actionList’ element is a set of processes (actions) for implementing the function executed by the functional sections 101 possessed by the RSE system 300 identified by the value of the ‘deviceName’ attribute, expressed as a list.

For example, the ‘actionList’ element has ‘action’ elements as subelements. An ‘action’ element corresponds to a process for implementing one function executed by a functional section 101 possessed by the RSE system 300 identified by the value of the ‘deviceName’ attribute.

As subelements, an ‘action’ element has a ‘name’ element and an ‘argumentList’ element. The ‘name’ element is a process name, which is process identification information for identifying a process; the ‘argumentList’ element is a list of arguments related to the execution of the process identified by the ‘name’ element.

An ‘argumentList’ element has ‘argument’ elements as subelements. An ‘argument’ element is a single argument related to the execution of the process.

An ‘argument’ element has a ‘name’ element, a ‘direction’ element, and a ‘relatedStateVariable’ element. The ‘name’ element is an argument name, which is argument identification information for identifying the argument. The ‘direction’ element is input/output identification information indicating whether the argument is an input argument or an output argument. In the ‘direction’ argument, ‘in’ indicates an input argument and ‘out’ indicates an output value. The ‘relatedStateVariable’ element is a value or argument indicating an associated condition needed for executing the process.

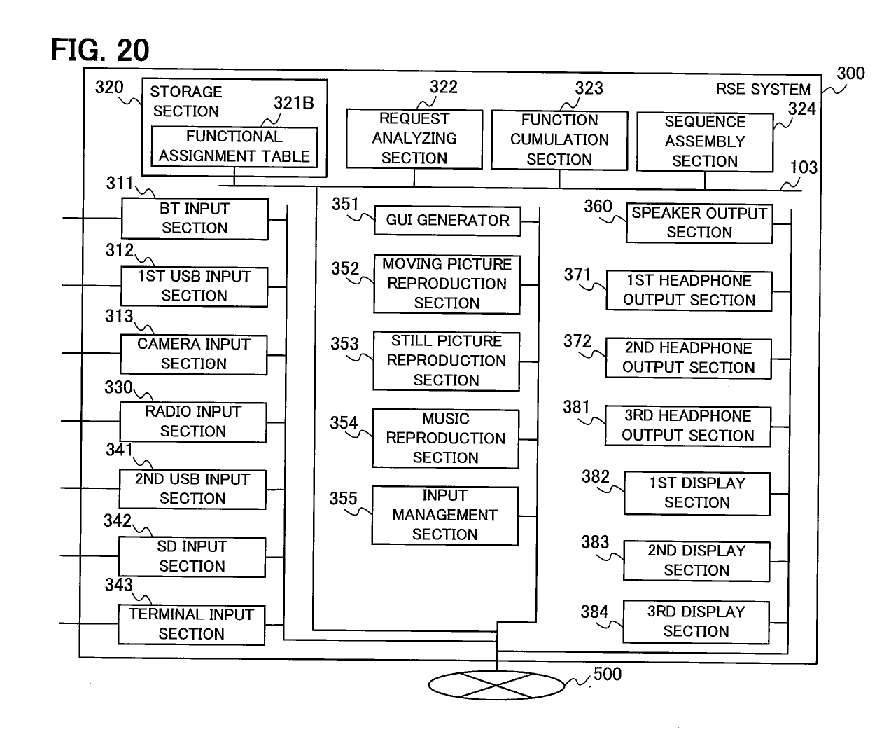

A generalized RSE system 300 is configured as above; an RSE system 300 that displays a plurality of input content of various types is configured as shown in, for example, FIG. 20.

FIG. 20 is a block diagram schematically showing an example of the configuration of the RSE system 300 according to the third embodiment. Components having the same reference characters as in FIG. 18 will be assumed to be configured in the same way as in FIG. 18.

Reference characters 320 denote a storage section that stores a functional assignment table 321B as exemplary functional data 102, which are data listing a set of functions derived from the analyzing of a request.

Reference characters 322 denote a request analyzing section that acquires a request presented to the RSE system 300, and generates a functional analysis table 321B by analyzing it.

Reference characters 323 denote a function cumulation section that identifies devices (RSE systems 300) having functional sections 101 that execute functions indicated in the functional analysis table 321A. The function cumulation section 323 generates the functional assignment table 321B by updating the functional analysis table 321A by associating the identified devices with the functions indicated in the functional analysis table 321A.

Reference characters 324 denote a sequence assembly section that determines the sequence in which the functions indicated by the functional assignment table 321B will operate, and causes the functional sections 101 to perform processing in the sequence thus determined.

Reference characters 311 denote a BT input section that receives Bluetooth (registered trademark) radio waves, connects to an external mobile information device, music reproduction device, or the like, not shown in the drawings, and inputs music data, picture data, moving picture data, or the like. In other words, the BT input section 311 receives data transmitted wirelessly.

Reference characters 312 denote a first USB input section that connects to an external USB device, not shown in the drawings, and inputs music data, picture data, moving picture data, or the like. In other words, the first USB input section 312 receives data from an external source over wires.

Reference characters 313 denote a camera input section that connects to an external camera device such as the rear camera of an automobile, for example, and inputs moving picture data or the like. In other words, the camera input section 313 inputs audio data or video data, or both, from an external video distribution device.

Reference characters 330 denote a radio input section that receives radio signals such as FM or AM signals and outputs audio data.

Reference characters 341 denote a second USB input section that connects to an external USB device, not shown in the drawings, and inputs music data, picture data, moving picture data, or the like. In other words, the second USB input section 341 receives data from an external source over wires.

Reference characters 342 denote an SD input section that connects to an external storage device such as an SD card, not shown in the drawings, and inputs music data, picture data, moving picture data, or the like. In other words, the SD input section 342 receives data from external media.

Reference characters 343 denote a terminal input section that connects to an external terminal device such as an external mobile information device, mobile music device, or the like, not shown in the drawings, and inputs music data, picture data, moving picture data, or the like. In other words, the terminal input section 343 inputs audio data or video data, or both, from an external terminal device.

Here, at least one of the BT input section 311, first USB input section 312, camera input section 313, radio input section 330, second USB input section 341, SD input section 342, and terminal input section 343 constitutes an input section for input of data.

Reference characters 351 denote a GUI generator that generates a graphical user interface (GUI) for selection of operations by the user of the RSE system 300.

Reference characters 352 denote a moving picture reproduction section that decodes, corrects, and outputs moving picture data input from, for example, BT input section 311. In other words, the moving picture reproduction section 352 reproduces audio or video, or both, from the data input to the input section.

Reference characters 353 denote a still picture reproduction section that decodes, corrects, and outputs still picture data input from, for example, the BT input section 311. In other words, the still picture reproduction section 353 reproduces still pictures from the data input to the input section.

Reference characters 354 denote a music reproduction section that decodes, corrects, and outputs music data input from, for example, the BT input section 311. In other words, the music reproduction section 354 reproduces music from the data input to the input section.

Here, at least one of the moving picture reproduction section 352, still picture reproduction section 353, and music reproduction section 354 constitutes a reproduction section that reproduces content.

Reference characters 355 denote an input management section that supervises the utilization of the input from, for example, the first USB input section 312, SD input section 342, and so on. In other words, the input management section 355 manages the usage of the input section.

Reference characters 360 denote a speaker output section that outputs audio data output from the radio input section 330, moving picture reproduction section 352, music reproduction section 354, and so on to a speaker. In other words, the speaker output section 360 outputs sound reproduced by the reproduction section to the speaker.

Reference characters 371 denote a first headphone output section that outputs audio data output from the radio input section 330, moving picture reproduction section 352, music reproduction section 354, and so on to a pair of headphones.

Reference characters 372 denote a second headphone output section that outputs audio data output from the radio input section 330, moving picture reproduction section 352, music reproduction section 354, and so on to a pair of headphones.

Reference characters 381 denote a third headphone output section that outputs audio data output from the radio input section 330, moving picture reproduction section 352, music reproduction section 354, and so on to a pair of headphones.

In other words, the first headphone output section 371, second headphone output section 372, and third headphone output section 381 output sound reproduced by the reproduction section to the headphones.

Reference characters 382 denote a first display section that displays picture data output from the GUI generator 351, moving picture reproduction section 352, music reproduction section 354, and so on.

Reference characters 383 denote a second display section that displays picture data output from the GUI generator 351, moving picture reproduction section 352, music reproduction section 354, and so on.

Reference characters 384 denote a third display section that displays picture data output from the GUI generator 351, moving picture reproduction section 352, music reproduction section 354, and so on.

In other words, the first display section 382, second display section 383, and third display section 384 output video reproduced by the reproduction section.

Here, at least one of the speaker output section 360, first headphone output section 371, second headphone output section 372, third headphone output section 381, first display section 382, second display section 383, and third display section 384 constitutes an output section that outputs content reproduced by the reproduction section.

Reference characters 103 denote a network that interconnects the storage section 320, request analyzing section 322, function cumulation section 323, sequence assembly section 324, BT input section 311, first USB input section 312, camera input section 313, radio input section 330, second USB input section 341, SD input section 342, terminal input section 343, GUI generator 351, moving picture reproduction section 352, still picture reproduction section 353, music reproduction section 354, input management section 355, speaker output section 360, first headphone output section 371, second headphone output section 372, third headphone output section 381, first display section 382, second display section 383, and third display section 384. The network 103 is also connected to an external network such as the Internet 500.

The input section, reproduction section, and output section in FIG. 20 are exemplary; input, reproduction, and output sections equivalent to those in the RSE system 300 are not limited to those shown in the drawings, and it will be apparent that there may be RSE systems 300 with one or more input, one or more reproduction, and one or more output section.

The relationship between FIGS. 18 and 20 will now be described. Reference characters 311, 312, 313, 320-324, 330, 341-343, 351-355, 360, 371, 372 and 381-384 in FIG. 20 denote exemplary functional sections 101, and reference characters 321B denote exemplary functional data 102. The RSE system 300 in FIG. 20 has the functional sections indicated by reference characters 311, 312, 313, 320-324, 330, 341-343, 351-355, 360, 371, 372 and 381-384, but it is only necessary for a RSE system 300 to have at least one of these functional sections. The storage section 320, request analyzing section 322, function cumulation section 323, and sequence assembly section 324 are preferably located in one RSE system 300. If, however, these functional sections or an arbitrary combination thereof are divided among a plurality of RSE systems 300, it will be assumed that the RSE system 300 in which the request analyzing section 322, function cumulation section 323, or sequence assembly section 324 is located is provided with a functional section corresponding to the storage section 320. It will also be assumed that after creating the functional analysis table 321A, the request analyzing section 322 transmits the functional analysis table 321A to the function cumulation section 323, and that after creating the functional assignment table 321B, the function cumulation section 323 transmits the functional assignment table 321B and the functional descriptive data 104 acquired from each device to the sequence assembly section 324. It will also be assumed in this case that the communication address of the transmission destination is preset in the request analyzing section 322 and function cumulation section 323. Alternatively, the functional analysis table 321A and functional assignment table 321B may be located on a network that can be accessed by the request analyzing section 122, function cumulation section 323, and sequence assembly section 324 alike.

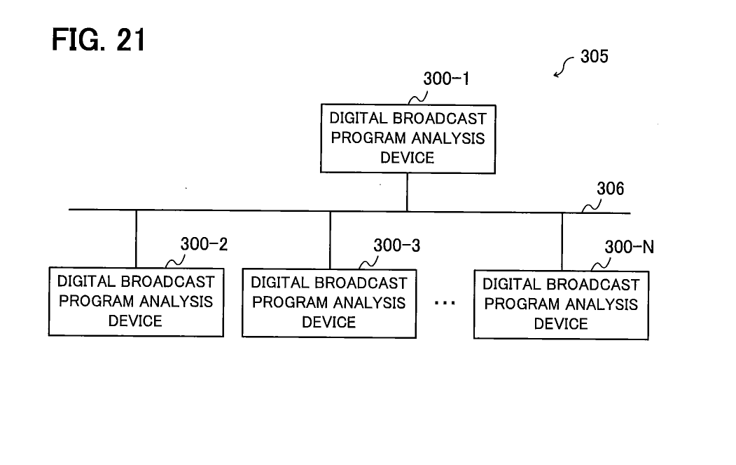

FIG. 21 is a schematic diagram of a display system 305 representing an information processing system configured by interconnecting a plurality of RSE systems 300 (300-1, 300-2, 300-3, . . . , 300-N) according to the third embodiment through an external network 306 such as, for example, a LAN.

The operation of the RSE system 300 according to the third embodiment configured as above will be described below.

First, the flow of processes up to the reproduction of content will be described; then how the flow of these processes is processed inside and outside the RSE systems 300 will be described.

The general flow of the processes performed by an RSE system 300 according to the third embodiment is similar to the process flow described in the first embodiment with reference to FIGS. 7, 8, and 9. The storage section 120, request analyzing section 122, function cumulation section 123, and sequence assembly section 124 in the first embodiment, however, become the storage section 320, request analyzing section 322, function cumulation section 323, and sequence assembly section 324 in the third embodiment.

As in the description of FIG. 9 in the first embodiment, the reason why no single device (RSE system 300) corresponds to the functions for fulfilling a single request is that the RSE systems 300 do not all have the same functional sections 101; for example, there may be a RSE system 300 with only a single functional section 101, as shown in FIG. 19. Therefore, if a request involves N functions and each RSE system 300 includes at most a single functional section 101, for example, then to fulfill this type of request, N RSE systems 300 including functions possessing different actions are necessary. To fulfill the request with this type of display system 305 requires a system configuration of the type shown in FIG. 21.

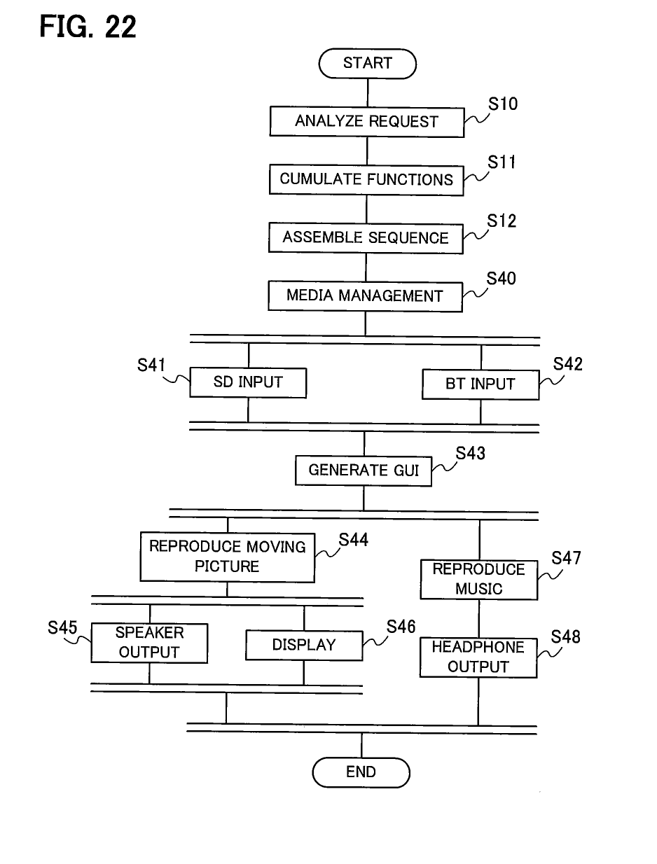

The description so far has dealt with the flow of execution of a generalized request; a case in which reproduction requests including a request to view moving picture content stored in an SD card and, simultaneously, a request to listen to music content stored in a Bluetooth-equipped device have been made will be taken up below with reference to FIG. 22.

The processing in steps S10 to S12 in FIG. 22 is similar to the processing in steps S10 to S12 in FIG. 7.

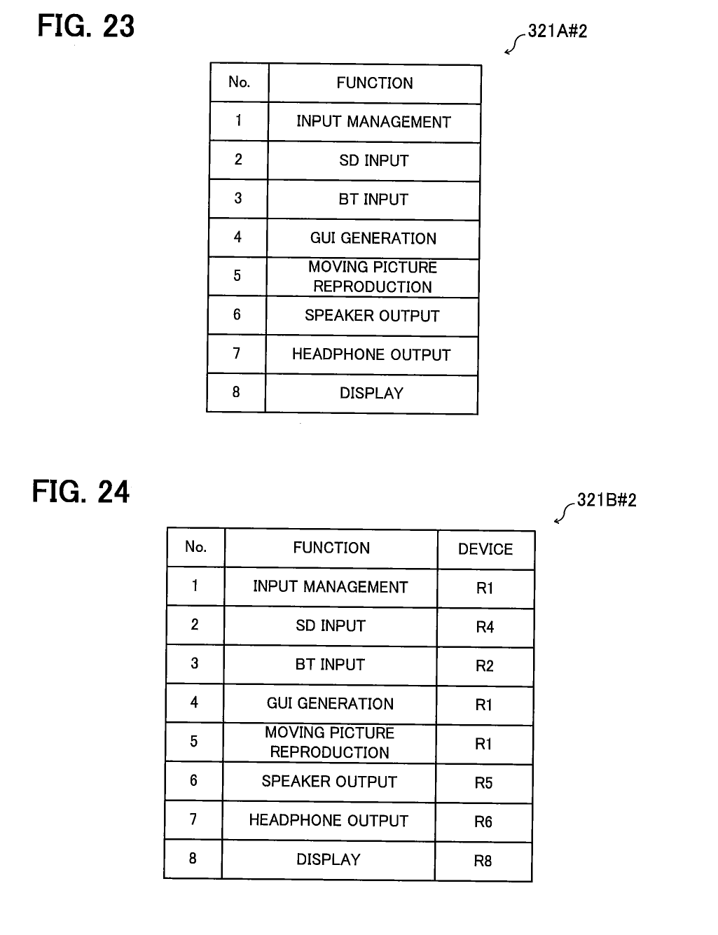

The functional analysis table 321A#2 generated by the analysis (step S10) of the RSE system requests to view moving picture content stored in an SD card (hereinafter, SD reproduction) and, simultaneously, to listen to music content stored in a Bluetooth-equipped device (hereinafter, BT reproduction) here is shown in FIG. 23. The functional assignment table 321B#2 generated by the function cumulation section 323 by identifying the devices having functional sections 101 that execute the functions listed in the functional analysis table 321A#2 is shown in FIG. 24.

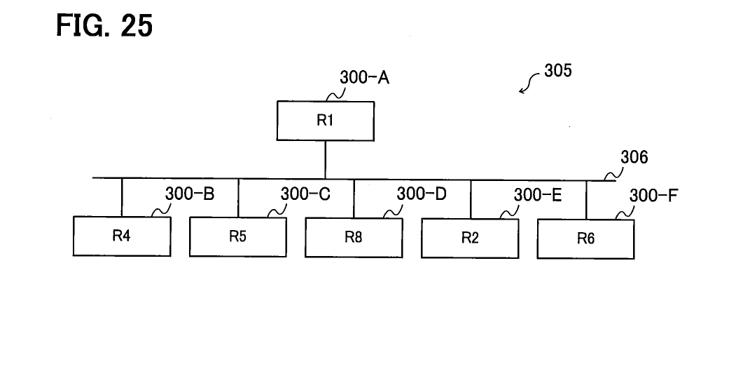

In FIG. 24, six RSE systems 300 constitute a system for eight functions. A diagram of the system configuration of the display system 305 is shown in FIG. 25. The number of functions is greater than the number of RSE systems 300 because the RSE systems 300 constituting the display system 305 respectively include a plurality of functional sections 101. For example, device R1 includes functional sections 101 for at least input management and a GUI generation.

Returning to the description of FIG. 22, in steps S40 to S48 in FIG. 22, the processes in the processing sequence identified in step S12 are executed according to that sequence by the corresponding devices.

FIG. 22 illustrates the flow in which two processes are executed simultaneously: a sequential process in which input for SD reproduction is selected by media management (S40), moving picture content data are input from the SD card (S41), a selection is made from a list of the input data displayed as a GUI (S42), and moving picture content selected in step S42 is reproduced (S44) and output from a speaker (S45) with simultaneous display of video (S46); and a process in which input for BT reproduction is likewise selected by media management (S40), music data are input from BT input (S42), a selection is made from a list of the input data displayed as a GUI (S42), and music data selected in step S42 are reproduced (S47) and output from headphones (S48). In this case as well, to execute the processing of the request efficiently, since SD input (S41) and BT input (S42), and moving picture reproduction (S44) and music reproduction (S47), are present as parallelizable functions, in sequence assembly (S12), a sequence that parallelizes these functions is assembled.

In the description of the third embodiment so far, a device is assigned to execute each function consisting of one or a plurality of actions, but a mode can also be adopted in which functions are grouped and a device is assigned to execute a group of functions.

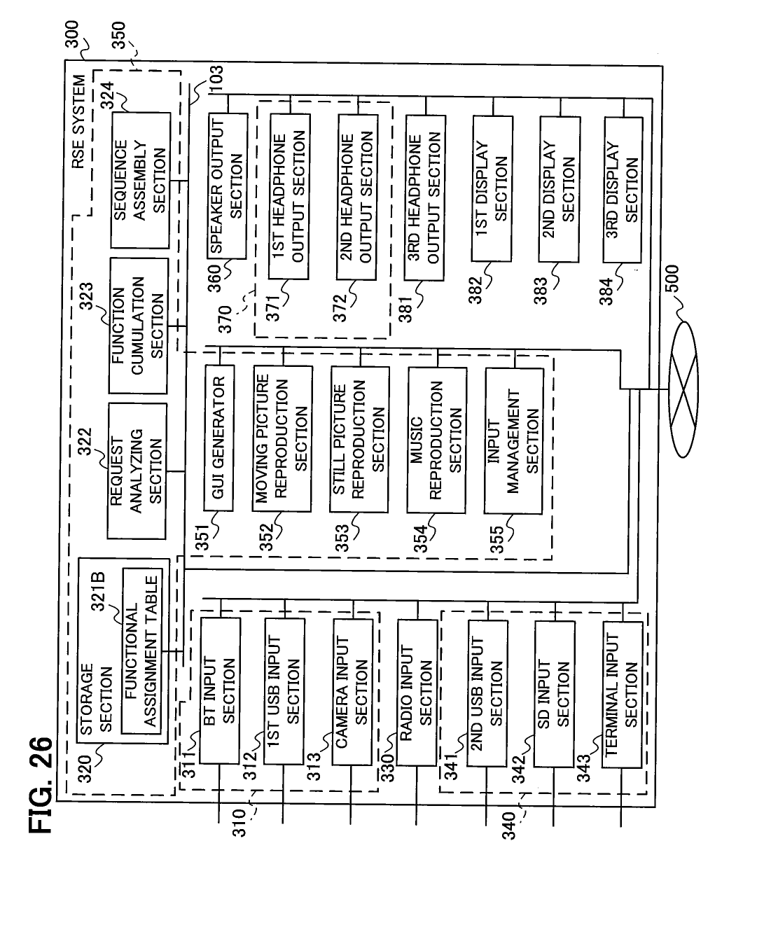

For example, the storage section 320, request analyzing section 322, function cumulation section 323, sequence assembly section 324, GUI generator 351, moving picture reproduction section 352, still picture reproduction section 353, music reproduction section 354, and input management section 355 can be grouped into a single functional group 350 as shown in FIG. 26. The BT input section 311, first USB input section 312, and camera input section 313 can be grouped into a single functional group 310. The second USB input section 341, SD input section 342, and terminal input section 343 can be grouped into a single functional group 340. The first headphone output section 371 and second headphone output section 372 can be grouped into a single functional group 370.

According to the RSE system 300 in the third embodiment as described above, as the result of an analysis of the functions needed to execute a request to reproduce content, a functional analysis table 321A is created, RSE systems 300 for executing the functions are identified on the basis of this functional analysis table 321A, and an operating sequence for executing the functions is identified. Therefore, since the RSE systems 300 can use the capabilities of a plurality of devices to fulfil the request, even when the processing power of each RSE system 300 is low, the reproduction of content can be carried out at high speed. Furthermore, since each RSE system 300 only has to carry out one or more functions and the control related to those functions, the software installed in each device can be simplified.

According also to the RSE system 300 in the third embodiment, since requests can be analyzed into groups of functions, one device can be identified to execute each group of functions. The construction of the operating sequence in which the request is executed is therefore less complex. In addition, a request can be fulfilled by a small number of RSE systems 300. The cost of providing enough RSE systems 300 to fulfill user requests can therefore be reduced.

In the third embodiment described above, as shown in FIG. 3, each functional section 101 has a communication unit 101c for connection with the network 103. This arrangement is merely exemplary, however, and is not limiting; for example, one of the functional sections 101 constituting the RSE system 300 may be a communication unit for connection to the external network 106. In that case, at least two or more functional sections 101 are needed in the RSE system 300. The functional sections 101 constituting the RSE system 300 may also exchange information over an internal bus instead of a network 103.

### REFERENCE CHARACTERS

100, 200 digital broadcast program analysis device, 101 functional section, 101a functional description unit, 101b functional processing unit, 101c communication unit, 110 broadcast program receiving section, 120, 220 storage section, 122, 222 request analyzing section, 123, 223 function cumulation section, 124, 224 sequence assembly section, 130 program information acquisition section, 131 text rendering section, 132 sentence delimitation section, 133 phrase delimitation section, 134 word extraction section, 135 frequency analysis section, 136 rank generating section, 137 important word detection section, 138 keyword selection section, 139 keyword search section, 140 display generating section, 150 display combining section, 311 BT input section, 312 first USB input section, 313 camera input section, 330 radio input section, 341 second USB input section, 342 SD input section, 343 terminal input section, 351 GUI generator, 352 moving picture reproduction section, 353 still picture reproduction section, 354 music reproduction section, 355 input management section, 360 speaker output section, 371 first headphone output section, 372 second headphone output section, 381 third headphone output section, 382 first display section, 383 second display section, 384 third display section.

1. An information processing system configured as a plurality of information processing devices connected to a network, comprising:
a request analyzing section for analyzing a request presented to the information processing system and identifying functions needed to fulfill the request;
a function cumulation section for identifying, from among the plurality of information processing devices, an information processing device to execute each of the identified functions;
a sequence assembly section for identifying an operating sequence in which the identified information processing devices are to execute the identified functions, and causing the identified information processing devices to execute the identified functions according to the identified operating sequence;
a broadcast program receiving section for receiving video and program information corresponding thereto from a broadcast signal;
a program information acquisition section for acquiring the received program information;
a word selection section for selecting words from the acquired program information;
a keyword extraction section for extracting keywords from the selected words;
a keyword search section for retrieving information related to the program information on a basis of the extracted keywords;
a display generating section for generating display data that display search results obtained in the keyword search section; and
a display combining section for combining the generated display data with the received video; wherein
the request analyzing section acquires a program related information display request to display information related to the received video, analyzes the program related information display request, and identifies functions needed to fulfill the program related information display request;
the function cumulation section identifies one information processing device from among the plurality of information processing devices to execute each identified function; and
the sequence assembly section identifies an operating sequence in which the identified information processing devices are to execute the identified functions, and causes one of the program information acquisition section, the word selection section, the keyword extraction section, the keyword search section, the display generating section, and the display combining section of the identified information processing device to execute each identified function according to the identified operating sequence.

2. The information processing system of claim 1, wherein:
the request analyzing section identifies a predetermined plurality of functions among the functions needed to fulfill the request as a functional group; and
when the request analyzing section identifies the functional group, the function cumulation section identifies a single information processing device that can execute all of the functions included in the functional group.

3. (canceled)

4. The information processing system of claim 1, wherein the word selection section comprises:
a text rendering section for generating text data by converting the acquired program information to text;
a sentence delimitation section for generating sentence data by delimiting sentences in the text data;
a phrase delimitation section for generating phrase data by delimiting phrases in the sentence data; and
a word extraction section for extracting words from the generated phrase data and thereby generating word data indicating the extracted words.

5. The information processing system of claim 1, wherein the keyword extraction section comprises:
a frequency analysis section for counting the usage of each word indicated by the word data and thereby generating frequency analysis data indicating a frequency of use of each word;
a rank generating section for generating ranking data indicating a rank of each word, giving higher ranks to more frequently used words, on a basis of the generated frequency analysis data;
an important word detection section for generating important word data indicating words ranked higher than a predetermined rank, on a basis of the generated ranking data; and
a keyword selection section for selecting keywords for search use from among the words indicated by the important word data.

6. The information processing system of claim 1, comprising:
an input section for input of data;
a reproduction section for reproducing content from the data input by the input section; and
an output section for output of the content reproduced by the reproduction section; wherein
the request analyzing section acquires a reproduction request for reproduction of the input data, analyzes the acquired reproduction request, and identifies functions needed to fulfill the acquired reproduction request;
the function cumulation section identifies one information processing device from among the plurality of information processing devices to execute each identified function; and
the sequence assembly section identifies an operating sequence in which the identified information processing devices are to execute the identified functions, and causes one of the input section, the reproduction section, and the output section of the identified information processing device to execute each identified function according to the identified operating sequence.

7. The information processing system of claim 6, wherein the input section comprises at least one of:
a BT input section for receiving data transmitted wirelessly;
a USB input section for input of data from an external source over wires;
a camera input section for input of audio data, video data, or both from an external video distribution device;
a radio input section for receiving a radio signal;
an SD input section for input of data from external media; and
a terminal input section for input of audio data, video data, or both from an external terminal device

8. The information processing system of claim 6, wherein the reproduction section comprises at least one of:
a moving picture reproduction section for reproducing audio, video, or both from the data input by the input section;
a still picture reproduction section for reproducing still pictures from the data input by the input section; and
a music reproduction section for reproducing sound from the data input by the input section.

9. The information processing system of claim 6, wherein the output section comprises at least one of:
a speaker output section for output of sound reproduced by the reproduction section to a speaker;
a headphone output section for output of sound reproduced by the reproduction section to headphones; and
a display section for display of video reproduced by the reproduction section.

10. An information processing method carried out by an information processing system configured as a plurality of information processing devices connected to a network, comprising:
a request analyzing step for analyzing a request presented to the information processing system and identifying functions needed to fulfill the request;
a function cumulation step for identifying, from among the plurality of information processing devices, an information processing device to execute each of the identified functions;
a sequence assembly step for identifying an operating sequence in which the identified information processing devices are to execute the identified functions, and causing the identified information processing devices to execute the identified functions according to the identified operating sequence;
a broadcast program receiving step for receiving video and program information corresponding thereto from a broadcast signal;
a program information acquisition step for acquiring the received program information;
a word selection step for selecting words from the acquired program information;
a keyword extraction step for extracting keywords from the selected words;
a keyword search step for retrieving information related to the program information on a basis of the extracted keywords;
a display generating step for generating display data that display search results obtained in the keyword search step; and
a display combining step for combining the generated display data with the received video; wherein
the request analyzing step acquires a program related information display request to display information related to the received video, analyzes the program related information display request, and identifies functions needed to fulfill the program related information display request;
the function cumulation step identifies one information processing device from among the plurality of information processing devices to execute each identified function; and
the sequence assembly step identifies an operating sequence in which the identified information processing devices are to execute the identified functions, and causes each identified information processing device to execute one of the program information acquisition step, the word selection step, the keyword extraction step, the keyword search step, the display generating step, and the display combining step according to the identified operating sequence.

11. The information processing method of claim 10, wherein:
the request analyzing step identifies a predetermined plurality of functions among the functions needed to fulfill the request as a functional group; and
when the request analyzing step identifies the functional group, the function cumulation step identifies a single information processing device that can execute all of the functions included in the functional group.

12. (canceled)

13. The information processing method of claim 10, wherein the word selection step comprises:
a text rendering step for generating text data by converting the acquired program information to text;
a sentence delimitation step for generating sentence data by delimiting sentences in the text data;
a phrase delimitation step for generating phrase data by delimiting phrases in the sentence data;
a word extraction step for extracting words from the generated phrase data and thereby generating word data indicating the extracted words.

14. The information processing method of claim 10, wherein the keyword extraction step comprises:
a frequency analysis step for counting the usage of each word indicated by the word data and thereby generating frequency analysis data indicating a frequency of use of each word;
a rank generating step for generating ranking data indicating a rank of each word, giving higher ranks to more frequently used words, on a basis of the generated frequency analysis data;
an important word detection step for generating important word data indicating words ranked higher than a predetermined rank, on a basis of the generated ranking data; and
a keyword selection step for selecting keywords for search use from among the words indicated by the important word data

15. The information processing method of claim 10, comprising:
an input step for input of data;
a reproduction step for reproducing content from the data input in the input step; and
an output step for output of the content reproduced in the reproduction step; wherein
the request analyzing step acquires a reproduction request for reproduction of the input data, analyzes the acquired reproduction request, and identifies functions needed to fulfill the acquired reproduction request;
the function cumulation step identifies one information processing device from among the plurality of information processing devices to execute each identified function; and
the sequence assembly step identifies an operating sequence in which the identified information processing devices are to execute the identified functions, and causes each identified information processing device to execute one of the input step, the reproduction step, and the output step according to the identified operating sequence.

16. The information processing method of claim 15, wherein the input step comprises at least one of:
a BT input step for receiving data transmitted wirelessly;
a USB input step for input of data from an external source over wires;
a camera input step for input of audio data, video data, or both from an external video distribution device;
a radio input step for receiving a radio signal;
an SD input step for input of data from external media; and
a terminal input step for input of audio data, video data, or both from an external terminal device

17. The information processing method of claim 15, wherein the reproduction step comprises at least one of:
a moving picture reproduction step for reproducing audio, video, or both from the data input in the input step;
a still picture reproduction step for reproducing still pictures from the data input in the input step; and
a music reproduction step for reproducing sound from the data input in the input step.

18. The information processing method of claim 15, wherein the output step comprises at least one of:
a speaker output step for output of sound reproduced in the reproduction step to a speaker;
a headphone output step for output of sound reproduced in the reproduction step to headphones; and
a display step for display of video reproduced in the reproduction step.
